(19) United States
(12) Patent Application Publication
(10) Pub. No.: US 2026/0141325 A1
(43) Pub. Date: May 21, 2026

(54) SYSTEM AND PROCESS FOR CREATING AUTOMATED GENERATIVE AI WORKFLOWS

(71) Applicant: Prudential Financial, Plymouth, MN (US)

(72) Inventor: Christian Balevski, Summit, NJ (US)

(73) Assignee: Prudential Financial, Plymouth, MN (US)

(21) Appl. No.: 18/949,849

(22) Filed: Nov. 15, 2024

Related U.S. Application Data
(63) Continuation of application No. 18/949,803, filed on Nov. 15, 2024.

(51) Int. Cl. G06Q 10/0633

(52) U.S. Cl. CPC G06Q 10/0633

(57) ABSTRACT

In accordance with at least one aspect of this disclosure, a computer implemented method and system for executing an automated workflow process for a job task is provided. The workflow process can include one or more logically ordered worker modules. The method comprises the steps of providing, by a computer processor, at least a first worker module for performing a first defined worker module task based upon input data to the first worker module; defining, by the computer processor, a workflow process, using the at least first worker module, for completing the job task, wherein defining the workflow process includes linking the at least first worker module to the workflow process; executing, by the computer processor; and generating, by the computer processor, an output from a last of the logically ordered worker modules, according to the job task.

### FIELD OF THE INVENTION

The illustrated embodiments generally relate to systems, methods, and apparatuses for generating workflows, and more particularly to systems and processes for creating automated generative artificial intelligence (AI) workflows.

### BACKGROUND OF THE INVENTION

Typical generative AI systems fall into one of two categories, either they are designed as chat interface systems that requires repeated prompting from the user to accomplish any sort of task, or they are designed for engineering/development staff to develop one-off workflows for very specific use-cases. For example, currently available workflow systems allow developers to create complex workflows of data retrieval, computer code, and large language model (LLM) calls, to create “LLM Apps” like customer service chatbots, etc. But these systems are designed to be used by developers and often require extensive experience in computer programming and software engineering to build any meaningful process or system.

The conventional techniques have been considered satisfactory for their intended purpose. However, there is an ever-present need for improved systems and processes for creating automated generative AI workflows, for example, that do not require a user to be highly skilled in computer programming. This disclosure provides a computer-implemented solution for this need.

### SUMMARY OF THE INVENTION

In accordance with at least one aspect of this disclosure, a computer implemented method and system for executing an automated workflow process for a job task is provided. The workflow process can include one or more logically ordered worker modules. The method preferably includes providing, by a computer processor, at least a first worker module for performing a first defined worker module task based upon input data to the first worker module, wherein the at least first worker module includes: 1) metadata, and 2) a prompt configured to cause initiation of one or more artificial intelligence (AI) techniques on the input data to perform the first defined worker module task. A computer processer defines a workflow process, using the at least first worker module, for completing the job task. Defining the workflow process includes preferably linking the at least first worker module to the workflow process. The computer processor executes the workflow process to perform the job task which includes execution of each worker module task for each worker module linked in the workflow process. The computer processor then preferably generates an output from a last of the logically ordered worker modules, according to the job task.

In certain embodiments, the input data can include structured data. In certain embodiments, the input data can include unstructured data. In certain embodiments, the input data can be captured from one or more documents provided to the worker. In certain embodiments, the input data can be captured from one or more external data sources via an application programming interface (API). In certain embodiments, the captured input data can be reformatted suitable for processing by the one or more of the logically ordered worker modules.

In certain embodiments, the generated output can include a tangible output suitable for a user. In certain embodiments, the generated output can include data suitable for input to a computer database.

In certain embodiments, the step of providing at least a first worker module can also include user selection of the first worker module from a computer directory of a plurality of predefined worker modules.

In certain embodiments, the metadata and/or prompt associated with each of the predefined worker modules can be editable by the user.

In certain embodiments, the step of defining the workflow process can further include graphically illustrating on a graphical user interface (GUI) of a computer display coupled to the processer, the first worker module in its logical positioning relative to any other worker modules defined in the workflow process. In certain embodiments, each of the worker modules linked together in the workflow process can be graphically illustrated on the GUI as a directed acyclic graph (DAG). In certain embodiments, the step of defining the workflow process can further include changing the logical positioning of one or more worker modules relative to other worker modules displayed on the GUI, via user interaction with the one or more worker modules displayed on the GUI.

In certain embodiments, the step of providing at least the first worker module, and any other worker modules, can include user selection of worker modules from a directory of predefined worker modules graphically illustrated on the GUI via user interaction with the GUI. In certain embodiments, the user interaction with the GUI can include of drag and drop functionality. In certain embodiments, the executing step can further include graphically illustrating on the GUI, real-time status of the workflow process being executed by the computer processor.

In certain embodiments, the one or more AI techniques can include utilization of a large language model (LLM). In certain embodiments, the LLM can be accessed by the computer processor via an application programming interface (API). In certain embodiments, the LLM can be accessed in a local framework coupled to the computer processor, or via a cloud computing environment.

In certain embodiments, the metadata can include, one or more of: a worker module name, worker module task description, input data description, and output data description. In certain embodiments, the input data received in one or more of the logically ordered worker modules can be captured from one or more preceding logical ordered worker modules in the defined workflow process. In certain embodiments, output data generated by one or more of the logically ordered worker modules can be captured as input data in one or more succeeding logical ordered worker modules in the defined workflow process. In certain embodiments, the output data can be structured suitable for use as input data by one or more succeeding logical ordered worker modules in the defined workflow process. In certain embodiments, the input data received in one or more of the logically ordered worker modules can be captured from one or more preceding logical ordered worker modules in the defined workflow process, and from at least one data source other than one or more of the preceding worker modules. In certain embodiments, the at least one data source consists of data captured from one or more electronic documents provided to the worker module.

In certain embodiments, the step of providing at least the first worker module can include generating, by a user, the at least first worker module, including one or more of: a) providing a description of the at least one worker module to an input data source; b) providing a set of instructions for the at least one worker module to the input data source; c) defining an input type for the worker; d) defining an output type for the at least one worker module and e) defining an output schema for the at least one worker module. The defined workflow process can include of a plurality of logically ordered in seriatim worker modules and/or a plurality of logically ordered parallel worker modules.

In certain embodiments, the computer-implemented method and system can further include the step of generating, by the user, a second worker module for performing a second defined worker module task. The second worker module can be generated in the same manner as the first worker module, and defining the workflow process using the first and second worker modules can include: linking the first worker module to the workflow process and linking the second worker module to the workflow process, and logically ordering the first worker module and the second worker module sequentially within the workflow process to perform the first worker module task and the second module task in a desired order. In certain such embodiments, executing the workflow process to perform the job can include, iteratively completing the first module task by the first worker module and the second worker module task by the second worker module in the desired order, where a terminal worker provides the tangible output to the user as record of completion of the job.

In certain embodiments, the computer-implemented method and system can further include the step of, generating, by the user, a plurality of additional worker modules for completing additional respective tasks, where each of the plurality of additional worker modules are generated in the same manner as the first worker module. In certain such embodiments, defining the workflow process using the first worker module, the second worker module, and the plurality of additional worker modules can include, linking the first worker module, the second worker module, and the plurality of additional worker modules to the workflow process; and logically ordering the first worker module, the second worker module, and the plurality of additional worker modules sequentially within the workflow process to perform the first worker module task, the second worker module task, and the additional respective worker module tasks in the desired order. In certain such embodiments, executing the workflow to perform the job task can further include, iteratively completing the first task by the first module worker, the second task by the second module worker, and each additional respective task by a respective additional module worker in the desired order, where a terminal worker provides the tangible output to the user as record of completion of the job task.

In certain embodiments, the computer-implemented method and system can further include the step of automatically storing all intermediate outputs of at least one worker module in a workflow log.

In certain embodiments, the computer-implemented method and system can also include the step of automatically storing each worker module in a computer library such that generating a worker module includes retrieving a worker module from the computer library, whereby defining the workflow process further includes linking the retrieved worker module to the workflow process.

In certain embodiments, each worker module can be specific to the worker module task but can be agnostic to the job task such that each worker module can be utilized for other job tasks performed by other workflow processes.

In certain embodiments, the computer-implemented method and system can further include the step of automatically storing each worker module in a computer library such that generating a worker module includes: retrieving a worker module from the computer library; editing one or more of: 1) the description of the retrieved worker module, 2) the set of instructions for the retrieved worker module, 3) the input type for the retrieved work module, 4) an output type for the worker module, and/or 5) the output schema for the retrieved worker module such that a new worker module is generated based on a previous worker module retrieved from the computer library whereby the new worker module is stored in the computer library for subsequent retrieval.

In certain embodiments, the computer-implemented method and system can further include the step of automatically storing each workflow process in a computer library such that generating a workflow includes retrieving a workflow process from the computer library; editing one or more of: 1) a description of the retrieved workflow process, 2) the set of instructions for one or more of the worker modules within the retrieved workflow process, 3) the input type for one or more worker modules within the workflow process, 4) output type, and/or 5) the output schema for one or more worker modules with in the retrieved workflow process, such that a new workflow process is generated based on a previous workflow process retrieved from the computer library whereby the new workflow process is stored in the computer library for subsequent retrieval. For example, the computer library can serve as a template library for both worker modules and workflow processes.

In certain embodiments, automatically generating a workflow from the library can include, providing a description for the workflow to generate a workflow template, adding or removing worker modules in the generated workflow template, reordering worker modules within the generated workflow template, configuring input sources for each worker module within the generated workflow template (either none, documents, or other workers), and providing additional context to the worker (if required), then saving the modified workflow template as a new workflow. When generating a new workflow (either automatically or manually) from the library, a user may not edit or update the set of instructions for the worker modules in the workflow template. Instead, if the instructions for the worker module does not exactly match the desired worker task, those workers can be replaced with new workers that better fit the task.

In certain embodiments, the input for the first worker module can be a financial document, and the first worker module task performed by the first worker module can be or include analyzing financial data from the financial document based on a user defined set of parameters, and the second worker module task performed by the second worker module can be or include generating a report based on the output of the first worker module.

In certain embodiments, a third task performed by a third worker module can include executing computer code to modify each input to the first worker module and the second worker module based on user defined context to increase efficiency of the first worker module and the second worker module without modifying the first worker module task or the second worker module task. In certain embodiments, the third worker module can be configured such that it works simultaneously with the first and second worker modules, but outside of the logical order defined by the workflow process. This type of worker can be referred to herein as a “utility worker.” In certain embodiments, utility workers can execute computer code (as described above), but utility workers are not limited to only modifying the input for downstream workers. For example, in certain embodiments, a utility worker can be a deterministic comparison worker, configured to run a traditional Natural Language Processing (NLP) algorithm such as n-gram comparison between multiple inputs, and the output of this utility worker can be for auditing or debugging purposes rather than modifying input for subsequent workers. In general, utility workers can be configured to act as functional units of computer code and/or can perform certain mathematical tasks and operations such as performing mathematical operations on data like sum, averages, min, max, and the like.

In certain embodiments, a third worker module task performed by a third worker module can include receiving information from an external communication means and executing computer code to modify each input to the first worker module and the second worker module based on user defined context to increase efficiency of the first worker module and the second worker module without modifying the first worker module task or the second worker module task, wherein the third worker module includes receiving an information output from the first worker module and/or the second worker module and executing computer code to send information to an external communication means to notify a user, via the external communication means, of the information received from the first worker module and/or the second worker module, and where the third worker module can be configured such that it works simultaneously with the first and second worker modules, but outside of the logical order defined by the workflow process.

In certain embodiments, a third worker module task performed by a third worker module can include making a logical decision about an input, and providing that decision as additional context to a downstream worker module. For example, where the first worker is an analyzing worker, configured to analyze a financial document, and the second worker is configured to generate a report based on the analysis by the first worker, the third worker can be configured to perform a preliminary review of the financial document, and logically choose one or more of the most important keywords or names (e.g., names of financial institutions) in the document(s), then provide the additional context of those keywords or names to the first worker, such that the first worker focuses its analysis on those key topics or institutions. The third worker in this example can be classified as a “pre-processing” worker and can use one or more AI techniques to make its own logical decision as to the additional context provided to the downstream worker based on its pre-processing review of the input. For instance, a generic worker can be created for extracting financial data from a report, a user can specify the company that the worker should focus on when extracting the financial data in the context of an industry-wide report. The additional context is applied to each input, whether the input is processed in aggregate or separate.

In certain embodiments, the input type for each worker module can be or include at least one of: an external media (e.g., from a document pool) and/or an output from another worker module linked to the workflow process. In certain embodiments, each worker module can be configured to analyze each input individually, or in aggregate with one another if multiple inputs are used.

In certain embodiments, a format of the tangible output can be a user readable report defined by the metadata provided to the worker module during generation of the worker module such that the user readable report includes only results within parameters defined by the metadata (e.g., worker instructions and predefined output schema).

In certain embodiments, the metadata of the worker module can be or include at least one of: the description of the worker module, the set of instructions, the input type, the output type and/or the output schema for the worker module. In certain embodiments, at least a portion of the metadata can be automatically generated based on a set of user selections from a menu of predefined options. In certain embodiments, at least a portion of the metadata can be automatically generated from a large language model (LLM) based on a set of user selections from a menu of predefined options. In certain embodiments, at least a portion of the metadata can be manually generated by the user.

In certain embodiments, it is contemplated that an entire workflow process can be automatically from the meta data, for example using an AI orchestrator configured to understand the description of the workflow and the desired output, generate the tasks that are needed in order to complete that workflow processes, search the computer library for matching workers and choose the worker modules that would be needed to complete the requisite tasks within the workflow processes, and organize them within the workflow process. In certain embodiments, the orchestrator can provide recommendations for generating another worker to do a task where a worker module does not already exist in the computer library, and in this case, the orchestrator can would automatically generate that worker module and it to the workflow based thereon. In certain embodiments, the orchestrator can search the computer library for a workflow process that most closely matches the description of the new workflow process, and automatically generate the new workflow process based on the stored workflow processes. In certain such embodiments, a user can further modify the meta data of the workflow processes or one or more of the worker modules based if needed, before saving and running the automatically generated workflow process.

In accordance with at least one aspect of this disclosure, a computer-implemented system for generating and managing workflows can include: a worker generation module configured to provide a plurality of worker modules based on user provided inputs, whereby each generated worker module is configured to perform a user defined worker task; a workflow generation module configured to generate a workflow process comprising a plurality of linked worker modules, where each workflow process is configured to perform a user defined job task comprised of a plurality of defined tasks performed by the plurality of linked worker modules; and a workflow run module configured to execute the workflow process on a computer processor to complete the user defined job task of the workflow process so as to provide a tangible output to the user based upon completion of the user defined job task.

In certain embodiments, the system can further include, a library of predefined worker modules configured to be linked with other worker modules in a workflow process. In certain embodiments, each worker module can be agnostic to the workflow process user defined job.

In certain embodiments, the system can include an additional context input module linked to the worker generation module configured to modify worker behavior. For example, the additional context module can provide supplemental or additional instructions to the worker module, or context can be provided by the user providing additional context to a specific worker instance within a workflow. Using the additional context input may modify the worker behavior only for workflow in which the worker is currently linked, but does not modify worker behavior for a worker stored in the library, for example. In certain embodiments, a worker may receive its additional context from a user, or from an upstream worker. For example, a certain workflow may require upstream workers within the workflow process to provide output or context to a downstream worker in such a way that it modifies the behavior of that downstream worker regarding how it processes its own input. The downstream worker then uses the additional context provided by the upstream worker, in combination with its initial instructions provided by the user, to process its inputs, both in aggregate and separately.

Configuring whether a worker module requires additional context or not is specified in the additional context instructions, which is presented to the user at runtime. An example of additional context can include: “What company should this worker focus on?” for a worker module that is configured to analyzing documents for financial trends over a period X. Because the additional context is presented at runtime, the additional context is not present within the initial worker module instructions, which in the example above could include “analyze documents for financial trends over period X.” This allows the worker modules additional versatility across different workflows. The additional context instructions can also be used to provide the appropriate context to an LLM at invocation.

In certain embodiments, the system can include a feedback input module linked to the worker generation module, configured to modify worker behavior, similar to the additional context input module, based on the output of the worker. For example, a feedback worker can be linked to the worker to monitor and measure a quality of the output of the worker relative to the worker instructions, and then provide feedback to the worker by providing new or supplemental additional context and/or by modifying the instructions for the worker to improve the quality of the output.

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

### BRIEF DESCRIPTION OF THE DRAWINGS

The accompanying appendices and/or drawings illustrate various, non-limiting, examples, inventive aspects in accordance with the present disclosure:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an Artificial Intelligence (AI) device utilized with one or more of the illustrated embodiments;

FIG. 4 illustrates a diagram depicting an AI server utilized with one or more of the illustrated embodiments;

FIG. 5 illustrates a schematic diagram depicting a generative AI workflow creation process in accordance with one or more of the illustrated embodiments;

FIG. 6 illustrates a schematic diagram depicting another generative AI workflow creation process in accordance with one or more of the illustrated embodiments;

FIG. 7 illustrates a schematic diagram depicting another generative AI workflow creation process in accordance with one or more of the illustrated embodiments, showing a communication scheme between one or more components of the system;

FIG. 8 illustrates a schematic diagram depicting a generative AI workflow process in accordance with one or more of the illustrated embodiments, showing a set of logically ordered workers within a workflow;

FIG. 9 illustrates an example graphical user interface used to create a worker to be used in a workflow;

FIG. 10 illustrates an example graphical user interface used to create another worker to be used in a workflow;

FIG. 11 illustrates an example graphical user interface used to create another worker to be used in a workflow;

FIG. 12 illustrates a schematic diagram depicting another generative AI workflow process in accordance with one or more of the illustrated embodiments, showing a set of logically ordered workers within a workflow;

FIG. 13 illustrates an example screen of a graphical user interface used to create a workflow, showing a worker library;

FIG. 14 illustrates an example screen of a graphical user interface used to create a worker to be used in a workflow;

FIG. 15 illustrates an example graphical user interface used to create a workflow, showing an input document library;

FIG. 16 illustrates an example graphical user interface used to create a workflow, showing a workflow library;

FIG. 17 illustrates an example generative AI workflow process generated in accordance with one or more of the illustrated embodiments, showing a set of logically ordered workers within the workflow, wherein the workers are shown connected using a directed acyclic graph format;

FIG. 18 shows another example of a generative AI workflow process;

FIG. 19 shows another example of a generative AI workflow process;

FIG. 20 shows another example of a generative AI workflow process;

FIG. 21 shows another example of a generative AI workflow process;

FIG. 22 shows another example of a generative AI workflow process;

FIG. 23 shows another example of a generative AI workflow process;

FIG. 24 shows another example of a generative AI workflow process; and

FIG. 25 shows another example of a generative AI workflow process.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. In accordance with the illustrated embodiments, machine learning techniques are preferably utilized for generating one or more components of a workflow processes, e.g., generating a worker module, and/or for generating all components of a workflow, including the workflow itself by automatically generating and organizing the necessary worker modules within the workflow process.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

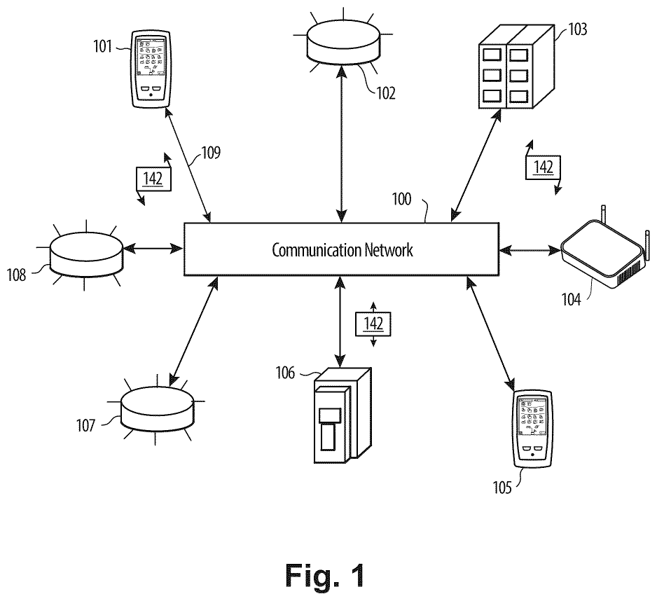

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103 (e.g., network monitoring devices), smart phone devices 105, web servers 106, routers 107, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “device”, “apparatus”, “module” or “system.” Furthermore, aspects of the illustrated embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++, Python, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a computer device, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

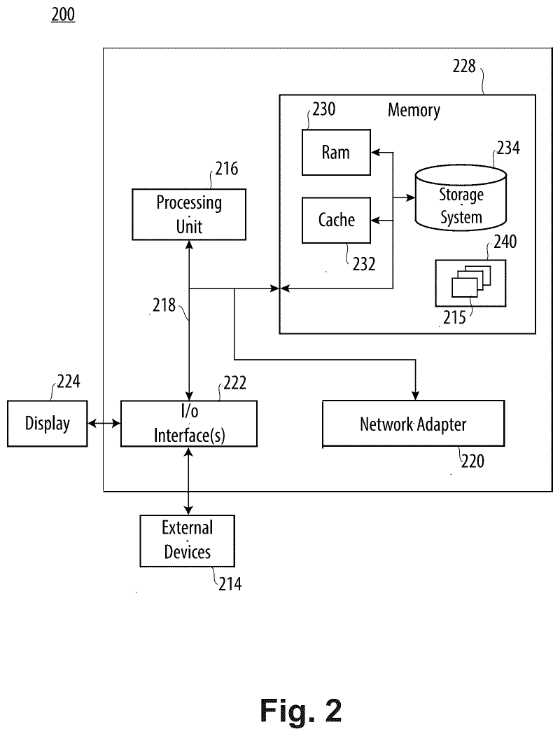

FIG. 2 is a schematic block diagram of an example network computing device 200 (e.g., client computing device 103, server 106, etc.) that may be used (or components thereof) with one or more embodiments described herein (e.g., as one of the nodes shown in the network 100) for determining the probability of an incident occurring to one or more computer applications resulting from one or more application change attributes through implementation of machine learning (ML) techniques. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein, particularly for creating, and executing, automated generative AI workflows in accordance with the illustrated embodiments.

It is to be understood and appreciated that computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network 100. In a distributed data processing environment, program modules may be located in both local and remote computer system storage media including memory storage devices.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random-access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments such as creating, and executing, automated generative AI workflows in accordance with the illustrated embodiments.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein for creating, and executing, automated generative AI workflows in one or more networked computer devices (e.g., 103, 106).

Device 200 may also communicate with one or more external devices 214 such as a keyboard, a pointing device, a display 224, etc. ; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood the embodiments described herein are preferably provided with Machine Learning (ML)/Artificial Intelligence (AI) techniques for creating, and executing, automated generative AI workflows in accordance with the illustrated embodiments through implementation of AI techniques. The computer system 200 is preferably integrated with an AI system (as also described below) that is preferably coupled to a plurality of external databases / data sources that implements machine learning and artificial intelligence algorithms in accordance with the illustrated embodiments. For instance, the AI system may include two subsystems: a first sub-system that learns from historical data; and a second subsystem to identify and recommend one or more parameters or approaches based on the learning for detecting anomaly events in computer devices. It should be appreciated that although the AI system may be described as two distinct subsystems, the AI system can also be implemented as a single system incorporating the functions and features described with respect to both subsystems.

Also in accordance with certain illustrated embodiments, a neural network (NN) may be used as the trained ML model for creating generative AI worker modules and/or workflows in accordance with the illustrated embodiments. It is to be appreciated that a neural network is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value. The artificial neural network preferably includes an input layer, an output layer, and one or more hidden layers. Each layer includes one or more neurons, and the artificial neural network may include a synapse that links neurons to neurons. In the artificial neural network, each neuron may output the function value of the activation function for input signals, weights, and deflections input through the synapse.

It is to be understood and appreciated that model parameters refer to parameters determined through learning and include a weight value of synaptic connection and deflection of neurons. A hyperparameter means a parameter to be set in the machine learning algorithm before learning, and typically includes a learning rate, a repetition number, a mini batch size, and an initialization function. The purpose of the learning of the neural network may be to determine the model parameters that minimize a loss function. The loss function may be used as an index to determine optimal model parameters in the learning process of the neural network. Machine learning may be classified into supervised learning, unsupervised learning, and reinforcement learning according to a learning method. The supervised learning may refer to a method of learning a neural network in a state in which a label for learning data is given, and the label may mean the correct answer (or result value) that the neural network must infer when the learning data is input to the artificial neural network. The unsupervised learning may refer to a method of learning a neural network in a state in which a label for learning data is not given. The reinforcement learning may refer to a learning method in which an agent defined in a certain environment learns to select a behavior or a behavior sequence that maximizes cumulative compensation in each state.

Is it to also be appreciated that machine learning, which is implemented as a deep neural network (DNN) including a plurality of hidden layers among neural networks, is also referred to as deep learning, and the deep learning is part of machine learning.

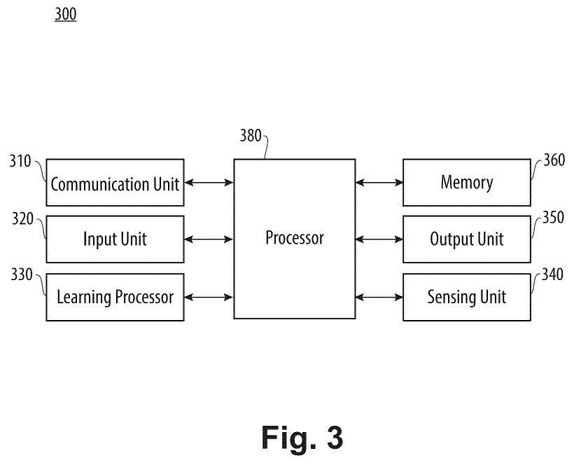

Referring now to FIG. 3, it illustrates an Artificial Intelligence (AI) monitoring device 300 according to an embodiment of the illustrated embodiments. The AI monitoring device 300 may be implemented by a stationary device or a mobile device, such as a web server, a desktop computer, a notebook, a desktop computer, and the like.

In conjunction with FIGS. 1 and 2, the AI monitoring device 300 of FIG. 3 is operatively coupled to, or integrated with computing device 200, in accordance with the illustrated embodiments described herein. AI monitoring device 300 preferably includes a communication unit 310, an input unit 320, a learning processor 330, a sensing unit 340, an output unit 350, a memory 360, and a processor 380. The communication unit 310 may transmit and receive data to and from external devices, such as other AI devices, by using wire/wireless communication technology. For example, the communication unit 310 may transmit and receive historical and contemplated application change attributes, a user input, a learning model, and a control signal to and from external devices, such as AI server 400.

The communication technology used by the communication unit 310 preferably includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

In accordance with the illustrated embodiments, the input unit 320 may acquire various kinds of data, including, but not limited to user prompts and metadata to be used to generate a desired worker to be linked to a workflow. The input unit 320 may acquire a learning data for model learning (e.g., a user prompt describing the task to be performed by the worker) and input data to be used when an output is acquired by using a learning model. The input unit 320 may acquire raw input data. The ML model in certain embodiments infers a result value for new input data rather than learning data, and the inferred value may be used as a basis for determination to perform a certain operation.

In certain illustrated embodiments, the learning processor 330 performs AI processing together with the learning processor 440 of the AI server 400, and the learning processor 330 may include a memory integrated or implemented in the AI monitoring device 300. Alternatively, in other illustrated embodiments, the learning processor 330 is implemented by using the memory 360, an external memory directly connected to the AI monitoring device 300, or a memory held in an external device.

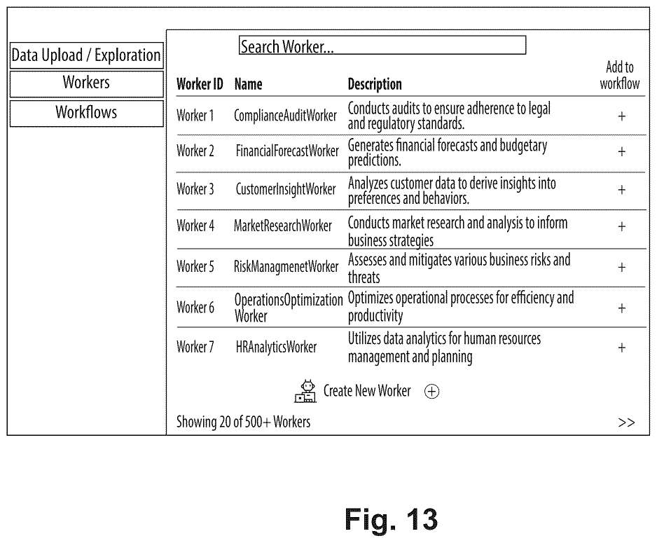

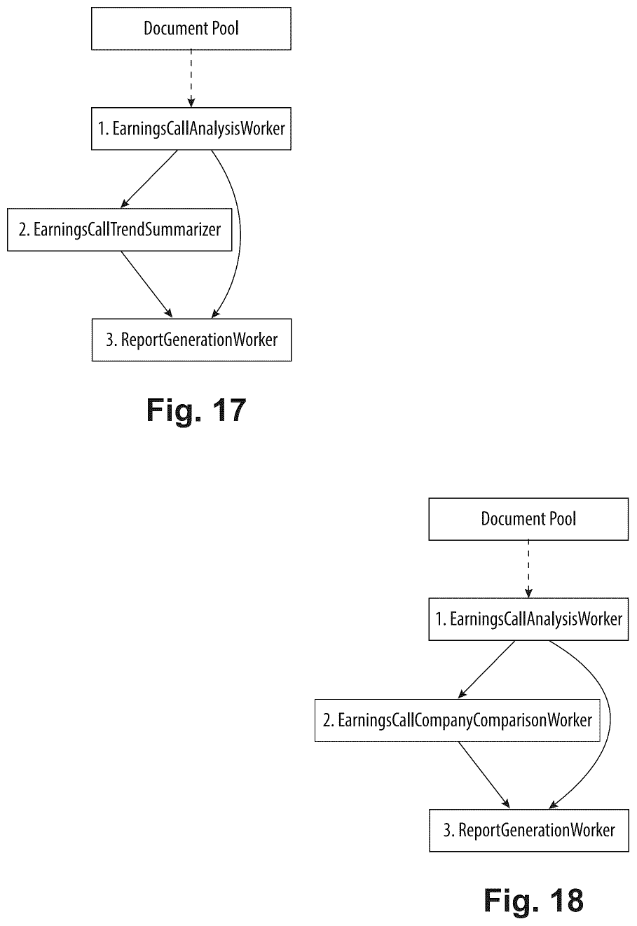

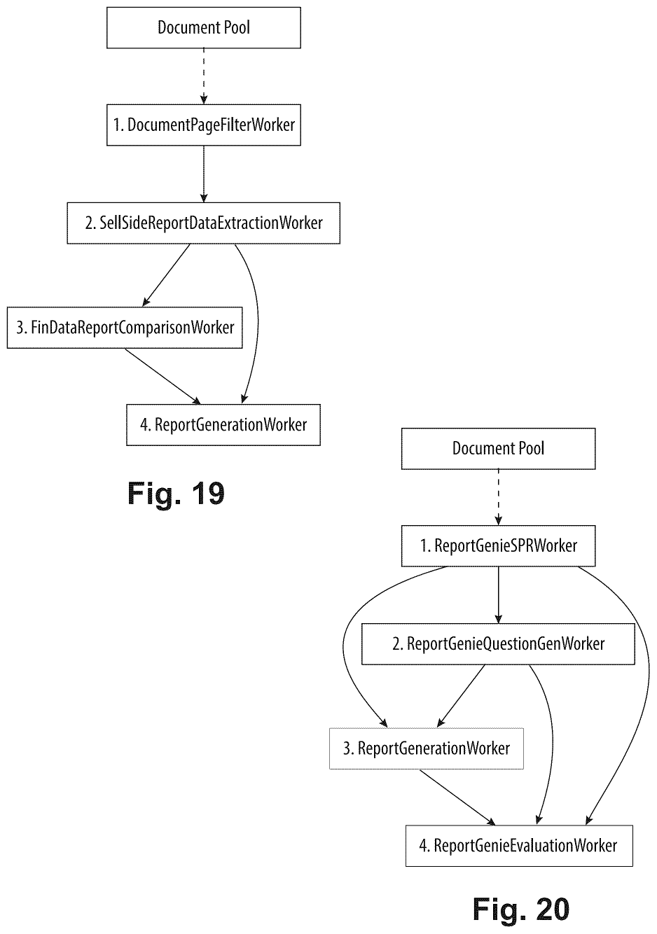

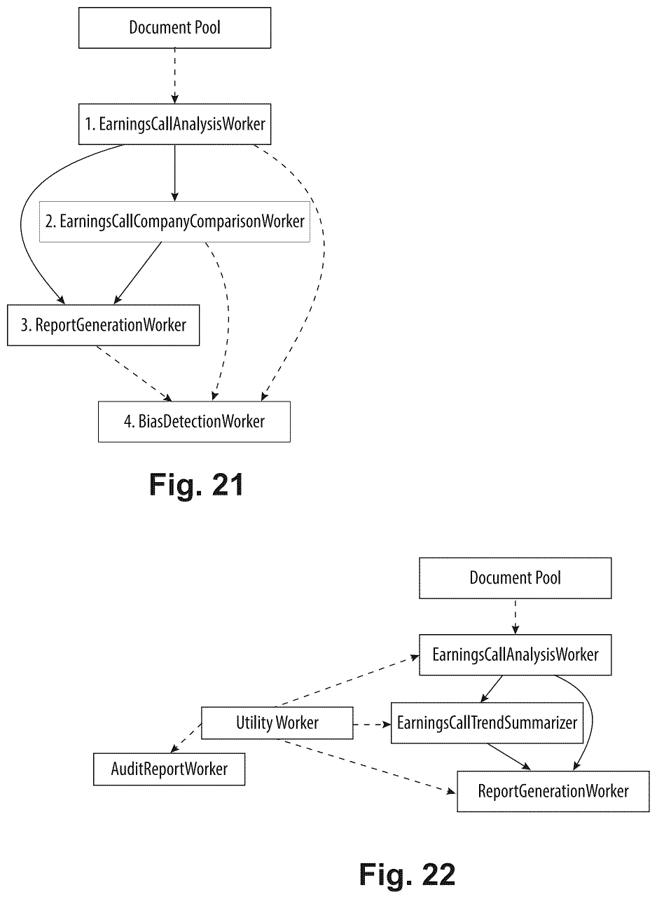

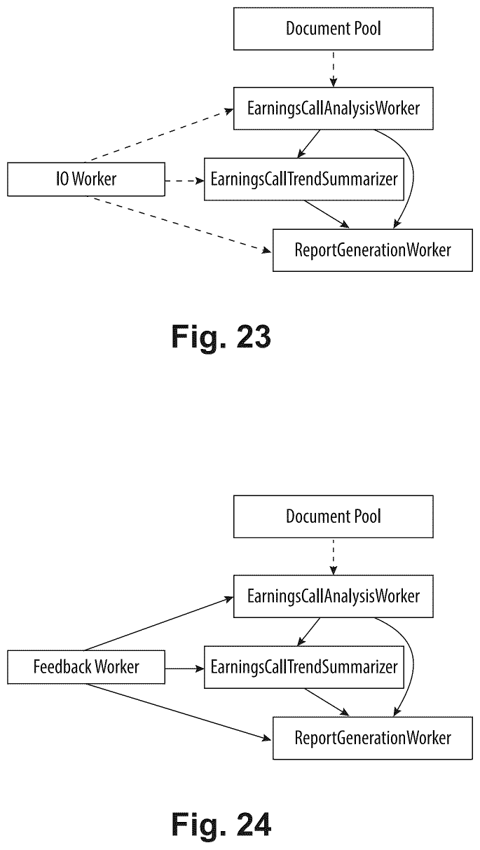

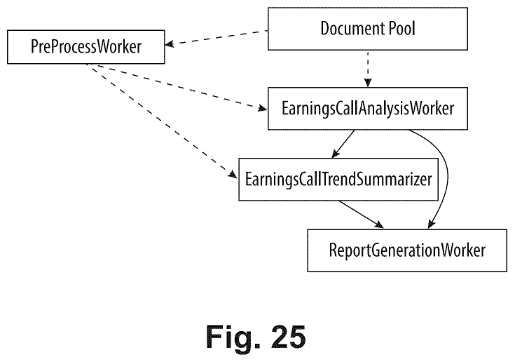

The output unit 350 preferably includes a display unit for outputting/displaying relevant information to a user in accordance with the illustrated embodiments described herein (e.g., the exemplary dashboard displays shown in FIGS. 13-16, and the graphs shown displayed in FIGS. 17-25). The memory 360 preferably stores data that supports various functions of the AI monitoring device 300. For example, the memory 360 may store input data acquired by the input unit 320, learning data, a learning model, a learning history, and the like.

The processor 380 preferably determines at least one executable operation of the AI monitoring device 300 based on information determined or generated by using a data analysis algorithm or a machine learning algorithm. The processor 380 may control the components of the AI monitoring device 300 to execute the determined operation. To this end, the processor 380 may request, search, receive, or utilize time-based metric data of the learning processor 330 or the memory 360. The processor 380 may control the components of the AI monitoring device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information. In some embodiments, the processor 380 may acquire the intention information corresponding to the user input by using at least one of a speech to text (STT) engine for converting speech input into a text string or a natural language processing (NLP) engine for acquiring intention information of a natural language.

In certain illustrated embodiments, at least one of the STT engine or the NLP engine may be configured as an artificial neural network, at least part of which is learned according to the machine learning algorithm. Thus, in certain illustrated embodiments, at least one of the STT engine or the NLP engine may be learned by the learning processor 330 or may be learned by the learning processor 340 of the AI server 400, or may be learned by their distributed processing. The processor 380 may collect history information including the operation contents of the AI monitoring device 300 or the user's feedback on the operation and may store the collected history information in the memory 360 or the learning processor 330 or transmit the collected history information to the external device such as the AI server 400. The collected history information may be used to update the learning model.

The processor 380 may control at least part of the components of AI monitoring device 300 so as to drive an application program stored in memory 360. Furthermore, the processor 380 may operate two or more of the components included in the AI monitoring device 300 in combination so as to drive the application program.

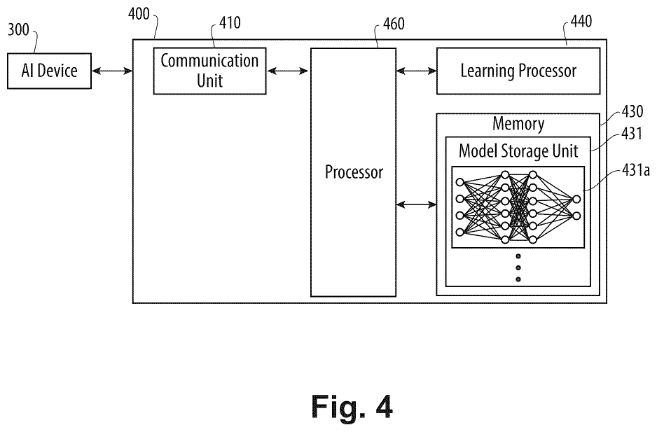

FIG. 4 illustrates an AI server 400 according to the certain illustrated embodiments that may utilize a neural network for ML. It is to be appreciated that the AI server 400 may refer to a device that learns an artificial neural network by using a machine learning algorithm or uses a learned artificial neural network. The AI server 400 may include a plurality of servers to perform distributed processing, or may be defined as a 5G network. Preferably, the AI server 400 is included as a partial configuration of the AI monitoring device 300, and performs at least part of the AI processing together. The AI server 400 may include a communication unit 410, a memory 430, a learning processor 440, a processor 460, and the like. The communication unit 410 can transmit and receive data to and from an external device such as the AI monitoring device 300. The memory 430 may include a model storage unit 431. The model storage unit 431 may store a learning or learned model (or a neural network 431a) through the learning processor 440.

The learning processor 440 may learn the artificial neural network 431a by using the learning data. The learning model may be used in a state of being mounted on the AI server 400 of the neural network or may be used in a state of being mounted on an external device such as the AI monitoring device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

With the exemplary communication network 100 (FIG. 1), computing device 200 (FIG. 2), AI monitoring device 300 (FIG. 3) and AI server 400 (FIG. 4) being generally shown and discussed above, description of certain illustrated embodiments will now be provided. It is to be understood and appreciated that exemplary embodiments implementing one or more components of FIGS. 1-4 relate to an Artificial Intelligence (AI) based computer system and method for creating generative AI worker modules and workflows. It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

The invention described herein and shown in the drawings relates to a workflow automation platform that allows users to setup workflows by leveraging generative AI (and without the user being required to program). A ‘workflow’ as used herein is a series of steps to process an organization's knowledge (consisting of, e.g., documents stored in a database). These workflows can be created by linking task-specific AI workers (worker modules) in a step-by-step fashion to complete specific processes. Each worker can be seen as a modular prompt. It sends its instructions, along with other inputs like documents or outputs from other workers to a language model. The outputs are either displayed directly or sent to other workers for further processing. Embodiments of the invention allows users the ability to leverage Large Language Models (LLMs) to automate workflows. For example, in simplified terms, a user could specify in plain English the objective(s) of a desired workflow. Embodiments of the system and method described herein can then take that objective, interface with a database where the knowledge is stored, create a workflow that satisfies that objective, and organize a collection of ‘workers’ that are configured to execute single tasks within that workflow.

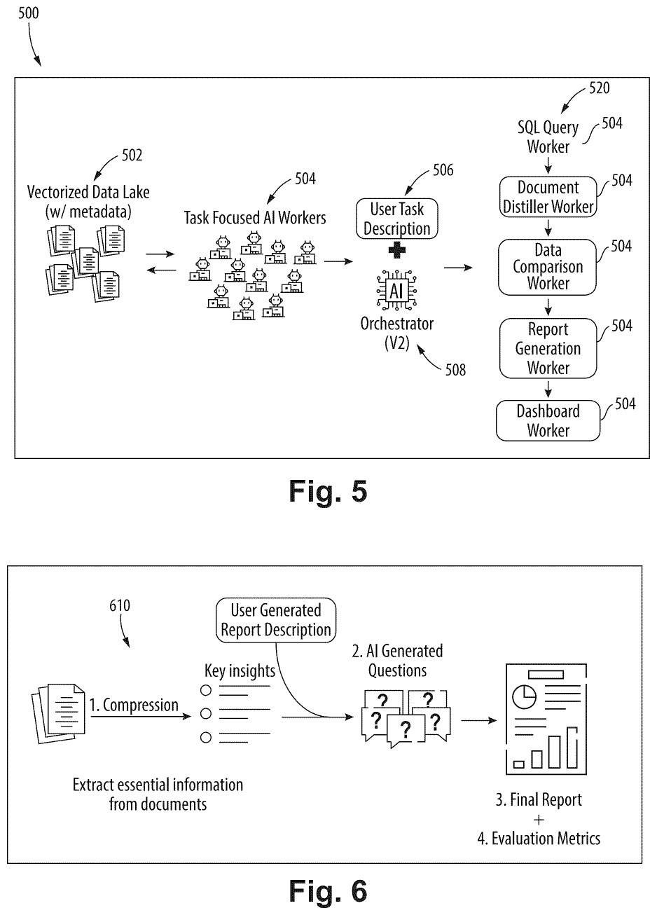

With reference now to FIGS. 5-25, in accordance with at least one aspect of this disclosure, a computer implemented method and system for executing an automated workflow process for a job task is shown and described. The workflow process can include one or more logically ordered worker modules, also called task-focused AI workers, each configured to perform a respective worker module task. The method can include providing, by a computer processor (e.g., client computing device 103), at least a first worker module for performing a first defined worker module task based upon input data to the first worker module. The method can further include, defining, by the computer processor, a workflow process, using the at least first worker module, for completing the job task, wherein defining the workflow process includes linking the at least first worker module to the workflow process. The method can further include, executing, by the computer processor, the workflow process to perform the job task comprising execution of each worker module task for each worker module linked in the workflow process, and generating, by the computer processor, an output from a last of the logically ordered worker modules, according to the job task.

FIG. 5 shows a method 500 for generating a generic workflow process 510 in which a plurality of worker modules 504 are configured to perform defined tasks on the vectorized data lake 502. In this generic example, the data lake 502 is a document pool. The worker modules 504 are provided with a user defined task description (e.g., a prompt) 506. The prompt can be user generated or can be generated in combination with an AI orchestrator 508. The user and/or AI orchestrator can then generate the workflow process by organizing the AI worker modules 504 into a logical order shown at 510.

FIG. 6 shows a more specific example of still a generalized workflow 610. In FIG. 6, the worker modules can be configured to read one or more input documents, and compress the information into key insights, based on some user generated prompt. The user can then also enter some additional context to the worker module, to cause the AI worker modules to extract the essential information from the summarized key insights, for example based on key words or topics. Additional worker modules can be provided to extract more data or perform other tasks such as comparisons. Then, the last worker modules in the workflow process can be configured to generate a final report of the findings, in a user readable format, plus provide some evaluation metrics.

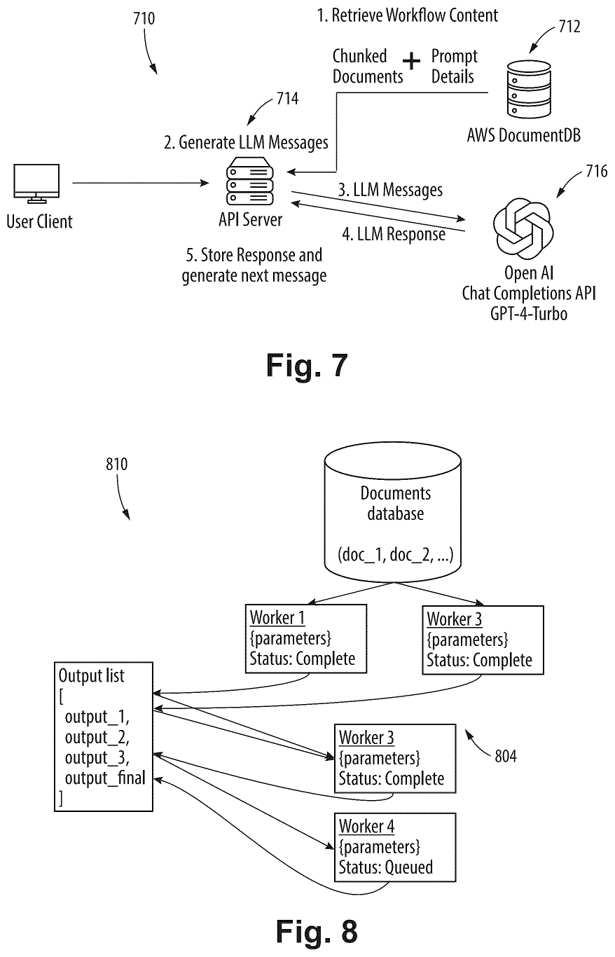

FIG. 7 shows a high-level architecture of a workflow 710. The input documents, e.g., documents to be read or analyzed by a worker module and the worker module prompts are made available to the application via the user or from a stored database 712, for example, a local drive or a cloud service. When the workflow is run, an API server 714 generates one or more request messages relating to the data input and the worker module prompts to be sent to a large language model (LLM) 716, or generative pre-trained transformer family, such as those hosted be OpenAI (e.g., Chat GPT). The LLM 716 provides a respective response back to the API server 714, which can then iteratively repeat this process for each worker module within a workflow, and for each workflow run by the user.

As used herein, a “job” is an instance of a workflow. When a job is running, each worker has a status such as Complete, Running, Queued, Cancelled, Failed, etc. Furthermore, so that each worker can access the appropriate outputs as determined by their input configuration, workers append their outputs to a centralized list of all outputs. Each entry to this list of outputs contains the worker ID and the content of that output, as can be seen in FIG. 8, for example. FIG. 8 shows a high-level workflow example 810, where the worker modules 804 are arranged in a logical order, and where each worker module output is linked to another worker module. For example, here, the documents database can serve as an input to worker 1 and worker 2 simultaneously, where each of worker 1 and worker 2 have their own defined parameters for the task they perform. Worker 1 outputs output 1, and worker 2 outputs output 2, worker 3 receives both output 1 and output 2, and outputs output 3. Worker 4, a terminal worker in the series, outputs output 4, which is tagged as final output. As shown in this example, each worker module can display a respective status indicator indicating whether their respective task is not started, queued, started, or complete.

To create a workflow, a user or an AI Orchestrator can arrange and configure several workers into a workflow. In the case of a user-configured workflow, a user manually determines the workers used in that workflow and the input and output arrangement of those workers. In certain cases, a user can rely on an AI Orchestrator to create a workflow configuration by taking a user-specified knowledge management operation and populating a configuration of workers into a workflow to accomplish that task. This will be described further hereinbelow.

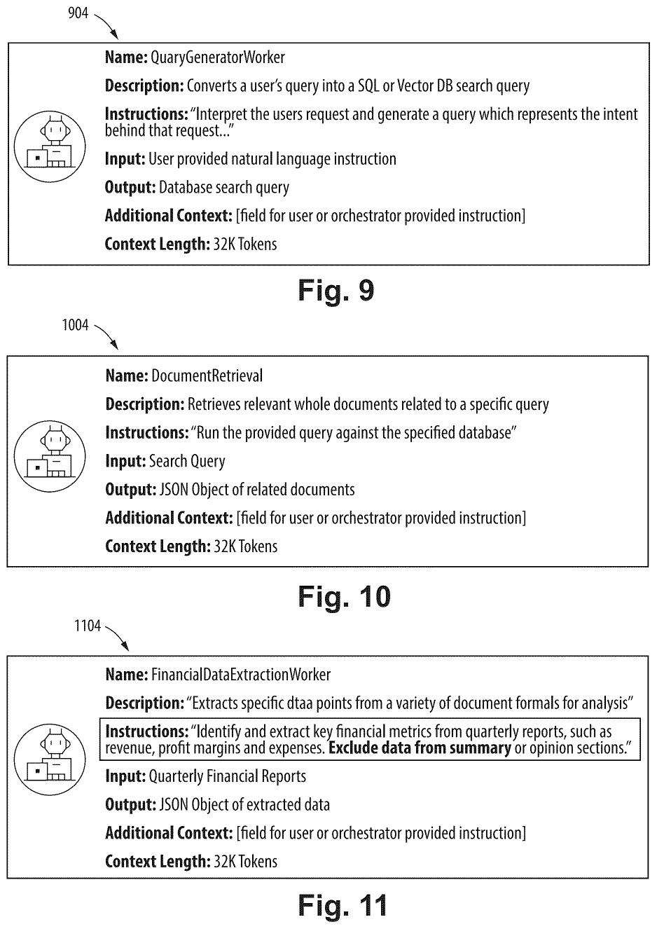

Turning now to FIGS. 9-11, the generation of a worker module will be described. Each worker module 904 can include at least: 1) metadata, and 2) a prompt configured to cause initiation of one or more artificial intelligence (AI) techniques on the input data to perform the first defined worker module task. For example, as shown in FIG. 9, a worker module for generating queries is shown. The meta data for worker 904 includes, a worker name, a worker description (e.g., a description of the task the worker will perform), worker instructions (e.g., the prompt), the input that the worker will perform the task on, the type of output the worker will produce, additional context metadata, and a context length. Any one or all of these fields can be user defined and entered manually by a user. However, it is also contemplated that one or more of the fields can be generated using AI techniques. FIG. 10 shows an example worker module 1004 for performing document retrieval task. FIG. 11 shows an example worker module 1104 for performing data extraction (in this example financial data). In the example of FIG. 11, the instructions, or prompt, includes both positive and negative instructions, for example, instructions to exclude a certain type of data from the output. In each of the examples shown in FIGS. 9-11, the additional context field is left blank, for a user to input. The additional context is also metadata used to tailor the worker to a more specific task, within the defined task. For example, in the example shown in FIG. 11, the worker can be a generic financial data extraction worker, but the additional context metadata can be used to tailor the worker to a more specific set of data, such as data only for a specific company name, or of a specific metric.

The input data for each worker module can include structured data or unstructured data. In certain embodiments, the input data can be captured from one or more documents provided to the worker, for example from the document pool or a data lake. In certain embodiments, the input data can be captured from one or more external data sources via an application programming interface (API), or from external communications, such as will be described further below. In certain embodiments, at least a portion of the metadata can be automatically generated based on a set of user selections from a menu of predefined options. In certain embodiments, at least a portion of the metadata can be automatically generated from a large language model (LLM) based on a set of user selections from a menu of predefined options. In certain embodiments, at least a portion of the metadata can be entirely manually generated by the user. In certain cases, the metadata can be generated from a combination of manual entry by the user, and by generation from an LLM.

In certain embodiments, the input data for a worker module can be the output from another worker module within the workflow. In certain embodiments, such as shown in the Figures, worker modules can have more than one input type, and/or the workers within the workflow can have different input data relative to one another. Depending on where the captured input data originates, the data can be reformatted suitable for processing by the worker modules, depending on the prompt given to the worker module.

With respect to worker outputs, each worker module can be configured to provide some output, either to the user, or to other workers, based on an output type and an output schema which is defined by the worker metadata at the creation of the worker module. A user can define the specific output schema for the output, for example defining the scheme to include certain information and exclude other information from a report generation, for example.

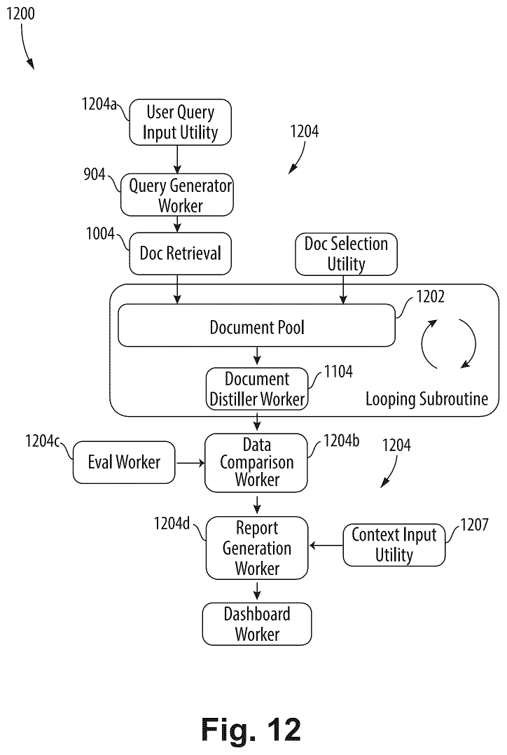

FIG. 12 shows an example workflow 1200, which comprises a plurality of logically ordered worker modules 1204 linked to one another. In this example workflow 1200, the first worker in the series, worker 1204a receives a query input from the user. The output from worker 104a is passed to the query generator worker 904 (discussed in FIG. 9) as its input so that worker 904 is able to generate the query based on the user input. The output of worker 904, the generated query, is then passed as input to the next worker, worker 1004 (discussed in FIG. 10), which retrieves a document from the document pool 1202, based on the generated query from worker 904. The worker 1004 retrieves the necessary documents and provides them as input to the next worker, worker 1104 (discussed in FIG. 11). Worker 1104 can be, as shown, a document distiller, or data retrieval worker, which extracts the relevant data from the selected documents, based on its prompt and any additional context provided. The distilled information from worker 1104 is passed as input to worker 1204b, which performs a comparison of the data, based on its prompt, for example if the data is financial, comparing between companies or time periods. The data comparison results are then passed as input to worker 1204c, a terminal worker, which generates a user readable report for the data comparison.

In the example of FIG. 12, a looping subroutine is shown. This functionality can be utilized so that workers need receive only one document from the pool as input but can be used within a loop to process many documents within the pool. Also, as the workflow is run, the system can automatically store all intermediate outputs of each worker module in a workflow log. Anytime a workflow is run, it produces a Job. A job is an instance of a workflow running a specific set of inputs at a given time. The job has an immutable output log that contains all intermediate and final outputs for every worker in the workflow (AI, utility, or IO workers). These intermediate and final outputs are user for debugging the workflow, auditing the workflow, and using the intermediate output and final outputs as ends of themselves. For instance, if a workflow generates a report but that report passes through a final evaluation worker that scores the report on its given criteria, the “final” output will be the scorecard produced by the final worker, but the most useful output will be the report produced by one of the intermediate workers, as that is the report the user intended to generate with the workflow job.

As shown with workers 1204b and 1204c, the workers can have more than one input. In 1204b, another worker can provide input, separate from, but alongside, the preceding worker, to improve the efficiency of the worker, or the quality of the output, for example. In this example, the eval worker 1204c can be configured to evaluate the quality of the data comparison and cause the comparison worker 1204b to rerun the comparison if errors are detected, for example. Regarding report generation worker 1204d, its additional input can come from additional context worker 1207, which can provide context as to how the report should look visually or be organized, for example based on user or client preference. The workers 1204 the generated output can include a tangible output suitable for a user. In certain embodiments, the generated output can include data suitable for input to a computer database, if the final output is not being produce for use by a user.

When creating a workflow, the user can create any suitable number of workers needed to complete the requested job. In the example shown and discussed in FIG. 12, the workflow 1200 is generated for allowing a user to prepare a report based on data extraction, where the data can financial data. To complete this job, the user would create a series of LLM workers (a prompt in their instructions that will be passed to a LLM at run time, along with the inputs to that LLM Worker), e.g., at least one worker module to review the input financial documents and extract the relevant data (worker 1104), at least one worker to compare the data (worker 1204b), and at least one worker to generate the report (worker 1204d). When generating the workflow, the workers should be linked to one another and order in a manner such that each worker receives the proper input to complete its own task, and ultimately flow together to complete the job.

In the example of workflow 1200, additional workers are included, which can be added by the user to make the workflow run more efficiently, or to increase the automation of the workflow, by minimizing the amount of input needed by the user upfront. These additional workers may not be LLM workers and my not utilize the LLM in the same manner as the LLM workers or may not use the LLM at all. Some workers can be referred to as “utility” workers (which are shown in FIG. 12 as “utility”), input/output, or IO, workers, or logical decision-making workers. Each of these kinds of workers will be discussed next, in turn.

A utility worker can be configured to perform a utility task, or a task that improves the utility of another worker. For example, a utility worker can be configured to execute computer code to modify the input(s) to one or more linked worker modules based on user defined context provided to the utility worker and/or can perform certain mathematical tasks and operations such as performing mathematical operations on data like sum, averages, min, max, and the like. The modification to the input of the linked worker module can be configured to increase the efficiency of the that worker module, but without modifying the task to be completed by the worker. Said differently, the utility worker does not affect the prompt or metadata of the worker to which it is linked. The utility worker thus works simultaneously with the worker modules to which it is linked, but outside of the logical order defined by the workflow process. For the example workflow 1200 shown in FIG. 12, utility workers 1207, for example, is outside of the worker flow, which runs in the direction of the downward pointing arrows. Examples of utility workers can include, a page-filtering worker, which directly filters pages of documents to include only relevant pages by, e.g., selecting pages containing a keyword provided by the user, or a personal identifiable information (PII) masking worker, which masks or otherwise removes PII from source documents to prevent them from entering the workflow.

While some utility workers can be configured to execute computer code to modify the input of a worker module, utility workers are not limited to this, or limited to modifying the input for downstream workers. For example, in certain embodiments, a utility worker can be a deterministic comparison worker configured to run a traditional Natural Language Processing (NLP) algorithm such as n-gram comparison between multiple inputs, and the output of this utility worker can be for auditing or debugging purposes rather than modifying input for subsequent workers. In general, though, utility workers can be configured to act as functional units of computer code.

The IO worker can be a worker module similar to the utility worker but can be further configured to send or receive input to/from external communication means. These IO workers can make external API calls and/or send data from the workflow to another location, which allow workflows to incorporate non-document information as an input and can message the user when a workflow job is complete, among other capabilities. For example, the IO worker can be linked to an email or messaging application, to use information from those communication means to modify input of a worker module based on the information received from the email or messaging application. Or the IO worker can be configured to take output from a worker module, and send the output as information to a user, via the external communication means, as a notification, for example. In certain embodiments, the IO worker can be configured to both send and receive information from the external communication means and modify the input of a worker module in view thereof. Similar to the utility workers, the IO workers can work at the same time as the ordered worker modules, but outside of the logical order.

The decision-making workers can be configured to make a logical decision about an input and provide that decision as additional context to a downstream worker module. For example, where a worker is prompted to complete an analyzing task, such as to analyze a financial document, the decision making worker can be linked to the workflow to perform a preliminary review of the financial document, and logically choose one or more of the most important keywords or names (e.g., names of financial institutions) in the document(s), then provide the additional context of those keywords or names to the document analyzing worker, such that the analyzing worker focuses its analysis only on those key topics or institutions. The decision making or “pre-processing” workers can use one or more AI techniques to make its own logical decision as to the additional context provided to the downstream worker based on its pre-processing review of the input. This kind of worker can allow for a more generic worker module to be used for a more specific task, without modifying the metadata data or prompt for that worker. For instance, a generic worker can be created for extracting financial data from a report, and the decision-making worker can specify the company and a time period that the worker should focus on when extracting the financial data in the context of an industry-wide report. The additional context can be applied to each input, whether the input is processed in aggregate or separate.

In general, each worker module can be specific to the worker module task but can be agnostic to the job task (e.g., the end job to be completed by the workflow) such that each worker module can be utilized for other job tasks performed by other workflow processes. A user can tailor the worker to their specific workflow either by modifying the metadata, the prompt, adding additional context, or by linking utility, IO, or decision-making workers. Having each worker be generic, it allows users to store workers in a library to be used by another user, for a different workflow, eliminating the need for creating duplicate workers for each workflow. Another means for tailoring the workers, or improving their output includes “additional context input modules” or feedback worker modules. In certain embodiments, the additional context input module can be a part of the worker module metadata, or can be provided by a decision-making worker, in certain instances.

The additional context input module can be linked to the worker generation module configured to modify worker behavior. For example, the additional context module can provide supplemental or additional instructions to the worker module, or context can be provided by the user providing additional context to a specific worker instance within a workflow. Using the additional context input may modify the worker behavior only for workflow in which the worker is currently linked but does not modify worker behavior for a worker stored in the library, for example. In certain embodiments, a worker may receive its additional context from a user, or from an upstream worker. For example, a certain workflow may require upstream workers within the workflow process to provide output or context to a downstream worker in such a way that it modifies the behavior of that downstream worker in regard to how it processes its own input. The downstream worker then uses the additional context provided by the upstream worker, in combination with its initial instructions provided by the user, to process its inputs, both in aggregate and separately.

A feedback input module can be linked to the worker generation module, configured to modify worker behavior, similar to the additional context input module, but instead based on the output of the worker. For example, a feedback worker module can be linked to the worker to monitor and measure a quality of the output of the worker relative to the worker instructions, and then provide feedback to the worker by providing new or supplemental additional context and/or by modifying the instructions for the worker to improve the quality of the output.

In certain embodiments, once a worker is created, it can be automatically saved to and stored within a database, or a library of workers. As more workers are generated and stored, the library will grow, providing a large repository of worker types for performing different tasks. Then, when a user needs to generate a new workflow, they need to only pick and choose the workers from the library and link them in a logical order for the specific workflow they are creating. To make the workers more specific, as needed, the worker in the workflow can be duplicated, and the metadata or prompts of the duplicate worker module can be edited, or the user can link utility, IO, or decision-making workers to the duplicate worker to further optimize the workflow. Modifying a worker within a workflow does not modify the worker stored in the worker library because a duplicate is created for the specific workflow in which the duplicate is now tied. If a worker is modified via duplication and modification, the modified version can then be stored in the library as well. Eventually, as more workers are stored, there will be no need for a worker to generate any new workers.

As with the workers, every time a workflow is generated, the workflow can be stored in a workflow library. In this case, a user may not need to generate a new workflow, but may choose an existing workflow, then modify only one or a few of the workers therein to tailor the workflow to their specific needs. This can include, adding, subtracting, reordering, or modifying the worker modules as needed based on the desired output. Modifying a workflow generated using a library workflow does not modify the workflow stored to the library. In certain embodiments, workflows that are shared can be understood as workflow templates. For example, a user can choose to use the template and run it as is or they can choose to make a copy of it and modify any of the workers/configurations in it and save it as a new workflow to the library.

In certain embodiments, the workers, or the workflows themselves can be generated using one or more AI techniques. In certain embodiments, the one or more AI techniques can include utilization of a large language model (LLM). In certain embodiments, the LLM can be accessed by the computer processor via an application programming interface (API). In certain embodiments, the LLM can be accessed in a local framework coupled to the computer processor, or via a cloud computing environment. When generating a workflow using one or more AI techniques, a user can present a prompt for generating a workflow, and an AI orchestrator can determine what workers would be needed to complete the workflow. The AI orchestrator can search the databases for an already generated workflow and modify it to fit the new prompt. In certain embodiments, the AI orchestrator can form a list of all workers that would be needed, then search the worker library for those workers and link them to the workflow, and if a worker is not in the library, the AI orchestrator can generate the worker in a similar manner as the user would do so manually. After creating the workflow, the AI orchestrator can be configured to then automatically run the workflow it created.

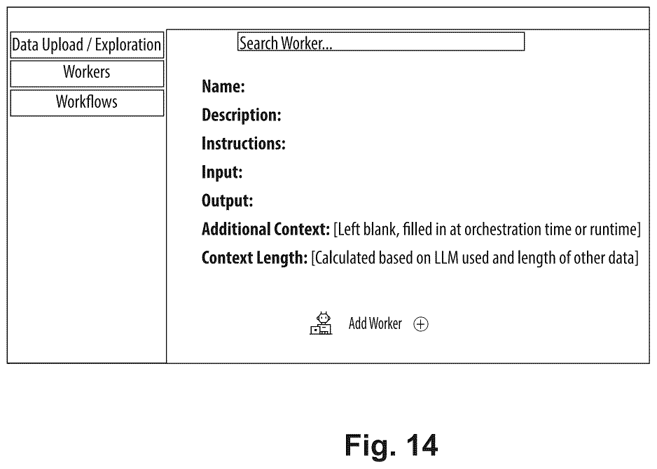

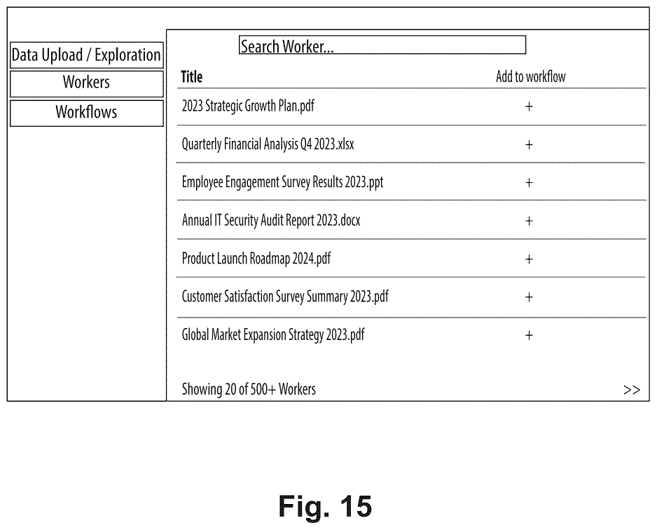

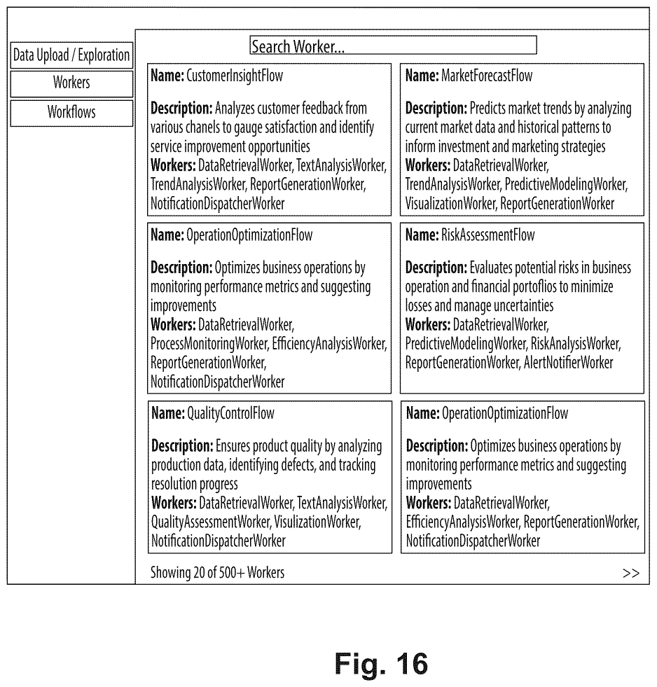

With reference now to FIGS. 13-16, defining the workflow process can further include graphically illustrating on a graphical user interface (GUI) of a computer display coupled to the processer, the worker library, a worker generation interface, the workflow library, a workflow generation interface, and a document library, among others. FIG. 13 shows an example of the worker library, which shows a worker number, a worker name, and a worker description. A user can search the database based on keywords appearing in the worker name and/or description, input/output type, and instructions. In certain embodiments the search can be configured for semantic or vector search based on worker name and/or description, input/output type, and instructions as well. Workers can be selected from this library and added directly to a workflow being generated. FIG. 14 shows an interface for worker generation, for example when a user chooses “create new worker” on the screen shown in FIG. 13. The fields shown in FIG. 14 are all editable by the user, either manually, or using one or more AI techniques can be used to automatically fill in the fields based on a user prompt. FIG. 15 shows an example interface for a document library, e.g., to be used as input for a worker, and FIG. 16 shows an example interface where a user can view the workflow library, to choose a workflow to run, or to use as a template for a new workflow. The workflow library displays the workflows in an easy-to-understand manner, providing the user with quick reference to the workflow name, the description, and which workers are lined.

As shown in FIGS. 17-25, each of the worker modules linked together in the workflow process can be graphically illustrated on the GUI as a directed acyclic graph (DAG). FIGS. 17-25 show various DAGs for several example workflows utilizing a number of different worker modules, utility workers, IO workers, decision making worker, and feedback workers. When a workflow is generated and the DAG is displayed for the user on the GUI, the user may utilize a drag and drop method to re-organize the workflow if needed. In certain embodiments, a user can generate a workflow by dragging and dropping worker modules onto a DAG, and rearranging within the GUI. In the example workflows shown in FIGS. 17-25, dotted lines can represent individual processing of inputs while solid lines indicate aggregate processing of inputs Additionally, any intermediate output (e.g., between worker modules) may be stored in a workflow log for debugging or audit purposes ..

Typical generative AI systems are designed to be used by developers and require extensive experience in computer programming and software engineering to build any meaningful process or system. Embodiments of the system and methods of the invention described herein, on the other hand, are designed to be used by non-engineering, domain experts, who can turn a high-level process into a codified generative AI workflow using a simple user interface. The invention is modular, extensible, re-configurable, and transparent. Embodiments separate the process of developing a prompt from using a prompt and encapsulates this prompt in an AI Worker which can be added to any workflow.

A workflows functionality is defined by the combination and connection of AI workers in that workflow. To change the functionality of a workflow, it can be as simple as swapping out one worker in the workflow. For instance, a workflow designed to analyze the past few quarters for earnings call transcripts for a given company vs a workflow designed to compare the earnings call across a few companies for a given quarter is only different by a single worker, one that either does comparisons or one that looks for trends (e.g., as shown in the difference between FIG. 17 and FIG. 18. To add functionality to an existing workflow, or to modify an existing workflow, a user simply needs to add a new worker with the desired functionality to the workflow and connect it to the various inputs to process, without the need to generate an entirely new workflow. In addition, the workflows generated by the invention describe multi-step processes which can be codified and shared amongst a team. All inputs and intermediate outputs from every worker can stored and be viewed and audited, providing increased control and transparency, an increasing concern in LLM applications.

Embodiments of the invention provide a generalized solution for solving complex tasks that often require reviewing and analyzing hundreds or thousands of pages of documents. The architecture and design of embodiment of the invention represent a general-purpose platform that isn't specifically built for one team or use-case, but instead builds modules that can be used for many tasks, or many workflows. For example, each worker module can be task specific but agnostic to the workflow job. By doing so, users can use the worker library or the workflow library to generate workers and workflows based on generic workers or workflows, that are then modified to be specific for a job. As an example, a document analysis worker can be made specific to financial jobs but tailoring it to analyze the documents for specific financial data and metrics. That same generic document analysis worker can be used in a healthcare workflow that searches for patient data when underwriting an insurance policy, for example. Similarly, a generic trend spotting workflow can be used in any number of applications, only being modified by the user to specify a particular context, such as financial versus healthcare. In this way, users can then accomplish specific tasks unique to their workflow or team without requiring custom development of the platform and allows users to build out additional functionality without requiring code, making the application much easier to use by a larger audience.

Embodiments of the invention provide novel and non-obvious improvement over conventional workflow applications, in addition to providing improvements to computer processing generally. In specific industries, tend spotting and data comparisons can be critical to business operations, for example with respect to understanding and adapting to industry trends, or monitoring and observing performance year over year with respect to certain key performance indicators. Reviewing and distilling this data requires review and analysis of massive amounts of documents (e.g., publicly available industry reports), or internal company documents and datasets. This is too large an undertaking to be reasonable completed by a human, especially withing a quick time fame, while the data is still relevant. Additionally, having separate applications that read the documents and distill the data based on specific, individualized metrics requires uses to generate new applications for each type of document or dataset to be reviewed, and can often require advanced coding or programming skills for a user to make the process more efficient. Thus, in these industries where such reports are needed, and often needed very quickly, the embodiment of the invention provide an improvement to workflow generation that is much faster to operate, and faster to generate than conventional means. Embodiments of the invention can be generated automatically using an AI orchestrator and based on a single user prompt, or a user can generate the workflow manually, but still without any coding or programming expertise. The modularity of the invention allows for quick and easy generation of workflow processes based on generic AI worker modules that can be tailored to specific applications, based on the workflow job, as well as for rapid scalability within a company. A repository of workers and workflows can be built along the way to avoid the need for creation of specific workers or workflows, or duplicates of each.

Accordingly, embodiments provide a specific improvement to the way computers operate, and more particularly, applications which generate workflows for distilling very large amounts of information into concise, user readable reports. Embodiments of the invention do not merely rely on the use of the computer but instead offer a distinct improvement on the existing technological processes by allowing the automation and scalability of further, including the generation of workflows, and workers within those workflows. Generating a worker or workflow, and running a workflow to complete a job, causes initiation of AI processing of a large language model, but with little input from the user. This opens the applications functionality to a much wider range of users, who may not be technically skilled in the field, but would greatly benefit from being able to access and utilize the technology that is otherwise reserved for experts.

With the certain illustrated embodiments described above, descriptions of the various embodiments of the illustrated embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-22. (canceled)

23. A computer implemented method for executing an automated workflow process for a job task, wherein the workflow process comprises one or more logically ordered worker modules, the method comprising the steps of:
a) providing, by a computer processor, at least a first worker module for performing a first defined worker module task based upon input data to the first worker module, wherein the at least first worker module includes: 1) metadata, and 2) a prompt configured to cause initiation of one or more artificial intelligence (AI) techniques on the input data to perform the first defined worker module task;
b) defining, by the computer processor, a workflow process, using the at least first worker module, for completing the job task, wherein defining the workflow process includes linking the at least first worker module to the workflow process;
c) executing, by the computer processor, the workflow process to perform the job task comprising execution of each worker module task for each worker module linked in the workflow process; and
d) generating, by the computer processor, an output from a last of the logically ordered worker modules, according to the job task,
wherein the step of providing at least the first worker module includes generating, by a user, the at least first worker module, including one or more of: a) providing a description of the at least one worker module to an input data source; b) providing a set of instructions for the at least one worker module to the input data source; c) defining an input type for the worker; d) defining an output type and e) defining an output schema for the at least one worker module.

24. The computer-implemented method as recited in claim 23, wherein the defined workflow process comprises of a plurality of logically ordered in seriatim worker modules and/or a plurality of logically ordered parallel worker modules.

25. The computer-implemented method as recited in claim 24, further including the step of generating, by the user, a second worker module for performing a second defined worker module task, wherein the second worker module is generated in the same manner as the first worker module, and wherein defining the workflow process using the first and second worker modules includes:
linking the first worker module to the workflow process and linking the second worker module to the workflow process;
logically ordering the first worker module and the second worker module sequentially within the workflow process to perform the first worker module task and the second module task in a desired order, wherein executing the workflow process to perform the job further includes:
iteratively completing the first module task by the first worker module and the second worker module task by the second worker module in the desired order, wherein a terminal worker provides the tangible output to the user as record of completion of the job.

26. The computer-implemented method as recited in claim 25, further including the step of, generating, by the user, a plurality of additional worker modules for completing additional respective tasks, wherein each of the plurality of additional worker modules are generated in the same manner as the first worker module, and wherein the defined workflow process using the first worker module, the second worker module, and the plurality of additional worker modules, further includes:
linking the first worker module, the second worker module, and the plurality of additional worker modules to the workflow process; and
logically ordering the first worker module, the second worker module, and the plurality of additional worker modules sequentially within the workflow process to perform the first worker module task, the second worker module task, and the additional respective worker module tasks in the desired order, and wherein executing the workflow to perform the job task further includes:
iteratively completing the first task by the first module worker, the second task by the second module worker, and each additional respective task by a respective additional module worker in the desired order, wherein a terminal worker provides the tangible output to the user as record of completion of the job task.

27. The computer-implemented method as recited in claim 26, further including the step of: automatically storing all intermediate outputs of at least one worker module in a workflow log.

28. The computer-implemented method as recited in claim 26, further including the step of: automatically storing each worker module in a computer library such that generating a worker module includes retrieving a worker module from the computer library, whereby defining the workflow process further includes linking the retrieved worker module to the workflow process.

29. The computer-implemented method as recited in claim 26, wherein each worker module is specific to the worker module task but is agnostic to the job task such that each worker module can be utilized for other job tasks performed by other workflow processes.

30. The computer-implemented method as recited in claim 26, further including the step of: automatically storing each worker module in a computer library such that generating a worker module includes:
retrieving a worker module from the computer library;
editing one or more of: 1) the description of the retrieved worker module, 2) the set of instructions for the retrieved worker module, 3) the input type for the retrieved work module, 4) the output type and/or 5) the output schema for the retrieved worker module such that a new worker module is generated based on a previous worker module retrieved from the computer library whereby the new worker module is stored in the computer library for subsequent retrieval.

31. The computer-implemented method as recited in claim 26, wherein the input for the first worker module is a financial document, and wherein the first worker module task performed by the first worker module includes analyzing financial data from the financial document based on a user defined set of parameters, and wherein the second worker module task performed by the second worker module includes generating a report based on the output of the first worker module.

32. The computer-implemented method as recited in claim 31, wherein a third task performed by a third worker module includes executing computer code to modify each input to the first worker module and the second worker module based on user defined context to increase efficiency of the first worker module and the second worker module without modifying the first worker module task or the second worker module task, wherein the third worker module works simultaneously with the first and second worker modules, outside of the logical order defined by the workflow process.

33. The computer-implemented method as recited in claim 32, wherein a third worker module task performed by a third worker module includes receiving information from an external communication means and executing computer code to modify each input to the first worker module and the second worker module based on user defined context to increase efficiency of the first worker module and the second worker module without modifying the first worker module task or the second worker module task, wherein the third worker module includes receiving an information output from the first worker module and/or the second worker module and executing computer code to send information to an external communication means to notify a user, via the external communication means, of the information received from the first worker module and/or the second worker module, and wherein the third worker module works simultaneously with the first and second worker modules, outside of the logical order defined by the workflow process.

34. The computer-implemented method as recited in claim 26, wherein the input type for each worker module is at least one of: an external media and/or an output from another worker module linked to the workflow process, and wherein each worker module is configured to analyze each input individually, or in aggregate with one another if multiple inputs are used.

35. The computer-implemented method as recited claim 23, wherein a format of the tangible output is a user readable report defined by the metadata provided to the worker module during generation of the worker module such that the user readable report includes only results within parameters defined by the metadata.

36. The computer-implemented method as recited claim 23, wherein the metadata of the worker module includes at least one of: the description of the worker module, the set of instructions, the input type, the output type and/or the output schema for the worker module, wherein at least a portion of the metadata are automatically generated based on a set of user selections from a menu of predefined options.

37. The computer-implemented method as recited claim 23, wherein the metadata of the worker module includes at least one of: the description of the worker module, the set of instructions, the input type, the output type and/or the output schema for the worker, wherein at least a portion of the metadata are automatically generated from a large language model (LLM) based on a set of user selections from a menu of predefined options.

38. The computer-implemented method as recited claim 23, wherein the metadata of the worker module includes at least one of: the description of the worker module, the set of instructions, the input type, the output type and/or the output schema for the worker module, wherein at least a portion of the metadata are manually generated by the user.

39-41. (canceled)

42. A computer-implemented method for executing an automated workflow process for a job task, wherein the workflow process comprises one or more logically ordered worker modules, the method comprising the steps of:
a) providing, by a computer processor, at least a first worker module for performing a first defined worker module task based upon input data to the first worker module, wherein the at least first worker module includes: 1) metadata, and 2) a prompt configured to cause initiation of one or more artificial intelligence (AI) techniques on the input data to perform the first defined worker module task;
b) defining, by the computer processor, a workflow process, using the at least first worker module, for completing the job task, wherein defining the workflow process includes linking the at least first worker module to the workflow process and graphically illustrating on a graphical user interface (GUI) of a computer display coupled to the processer, the first worker module in its logical positioning relative to any other worker modules defined in the workflow process;
c) executing, by the computer processor, the workflow process to perform the job task comprising execution of each worker module task for each worker module linked in the workflow process; and
d) generating, by the computer processor, an output from a last of the logically ordered worker modules, according to the job task.

43. The computer-implemented method as recited in claim 42, wherein each of the worker modules linked together in the workflow process are graphically illustrated on the GUI as a directed acyclic graph (DAG).

44. The computer-implemented method as recited in claim 43, wherein the step of defining the workflow process further includes changing the logical positioning of one or more worker modules relative to other worker modules displayed on the GUI, via user interaction with the one or more worker modules displayed on the GUI.

45. The computer-implemented method as recited in claim 45, wherein the step of providing at least the first worker module, and any other worker modules, includes user selection of worker modules from a directory of predefined worker modules graphically illustrated on the GUI via user interaction with the GUI.
